(19) United States
(12) Patent Application Publication
(10) Pub. No.: US 2007/0065634 A1
(43) Pub. Date: Mar. 22, 2007

(54) Use of an object as a decorative component

(76) Inventor: Hartmut Sauer, Wilnsdorf (DE)

Correspondence Address: FISH & RICHARDSON PC, P.O. BOX 1022, MINNEAPOLIS, MN, 55440-1022, US

(21) Appl. No.: 10/553,147

(22) PCT Filed: Apr. 15, 2004
(86) PCT No.: PCT/IB04/50460

§ 371 Date: Nov. 13, 2006

(30) Foreign Application Priority Data
Apr. 16, 2003 (DE) 10317798.1
Jan. 9, 2004 (DE) 102004001613.5

(51) Int. Cl. B32B 27/04; B32B 27/32; B32B 15/08

(52) U.S. Cl. 428/141; 428/457; 428/913.3; 428/299.1; 428/299.4; 428/523; 428/422

(57) ABSTRACT

Use of an article as decorative structural part whose surface exhibits a composite material, in full or in parts, the composite material consisting of a non-metallic substrate containing at least one polymer, and a metallic layer present thereon and deposited without external current, having an adhesive strength of at least 4 N/mm².

The present invention relates to the use of an article whose surface exhibits a composite material in full or in parts, the composite material consisting of a polymer and a metallic layer present thereon, as decorative structural part.

Objects with a surface exhibiting a composite material consisting of a polymer and a metallic layer present thereon are known.

In general, there are two different types of such articles:

On the one hand, those in the case of which at least one metal layer is deposited directly onto the plastic surface by a chemical process without electric current. The field of application of such articles is highly restricted as a result of the low adhesive strength of the metal layer applied without electric current and is almost exclusively in the decorative area such as e.g. chrome-plated articles of ABS (acrylic/butadiene/styrene polymers) or polymer blends, in particular decorative mouldings, showerheads, radiators grills of motor vehicles and coffee pots. A further disadvantage is that only a very restricted choice of materials is possible, particularly as regards the choice of polymer, if highly specific optical effects are to be achieved, such as e.g. a noble metal look, an aluminium look or the manifestation of a mat metal surface.

On the other hand, the use of such composite materials is known for decorative structural parts such as e.g. cases of mobile telephones, in the case of which the metal layer present on the plastic surface is produced by the vapour deposition of metal onto plastic in a vacuum (CVD/PVD process). In this way, closed metallic coatings are applied onto non-metallic substrates such as plastics. On account of the basic principle, this process has the disadvantage that, on the one hand, no articles of fairly large dimensions can be produced in an economic way on an industrial scale and, on the other hand, the metal layers have a thickness if maximum 3 μm. Moreover, articles with indentations or cavities are not completely metallised and the metal layer has only a very low adhesive strength such that its use for articles subject to mechanical stress is altogether impossible.

A wide-spread field of application for this vapour deposition technique is coating of plastic films, e.g. for food packaging. Thus, DE 198 49 661 A1 discloses the vapour deposition of aluminium onto a special polyester film in such a way that it exhibits a strong oxygen barrier, a high gloss and a low coefficient of friction. The adhesive strengths of up to 3 N/mm indicated therein, however, are too low to withstand to a functional application, subject to mechanical stress, of the metallised film.

In DE 43 12 926 A1, a process for the improvement of the adhesive strength of dental metal-polymer composite layers is described. For this purpose, a metallic substrate onto which a polymer has already been applied is irradiated with a special Te—CO₂ laser. If necessary, an adhesive agent is additionally used. A metallisation of plastic substrates is not described here.

DE 42 11 712 A1 also describes the irradiation of the surface of a substrate in order to improve the adhesive strengths with an Eximer laser. A PET (polyethylene terephthalate) film is irradiated with this special laser in order to subsequently apply a ferromagnetic metal layer by vapour deposition within the framework of a PVD process. Such films are used as audio or video recording medium, among other things.

In addition, a process exists for special plastics in the case of which the articles to be coated are first caused to swell with suitable substances and subsequently etched chemically. The adhesive strengths of the metal layer applied onto the plastic, which are thus achieved, amount to maximum 2 N/mm².

A major disadvantage of this process is the considerable environmental pollution by the two chemical treatment agents such that this process cannot be used much longer for considerations of environmental politics.

A process, which has been developed further, for metallising polyamides which is based on the principle, described above, of causing the surface of the plastic substrate to swell but does not provide for pickling with chromium sulphuric acid is presented in an article by G. D. Wolf and F. Fünger “Metallisierte Polyamid-Spritzguβteile” (metallised polyamide injection-moulded parts), Kunststoffe, 1989, pages 442-447. The surface of the amorphous polyamide is treated with an organometallic activator solution. Subsequently, a conventional plating process for depositing a chemical nickel layer is carried out.

A disadvantage of this type of surface treatment which is based on a chemical reaction of the treatment solution with the substrate is that the swollen surfaces are highly sensitive to environmental influences such as e.g. dust embedments. Moreover, the polyamide to be treated must be amorphous since partially crystalline or crystalline polyamides are not attacked by the method presented. Consequently, this method is a time-consuming, expensive process which has only limited use in order to achieve adhesive composite layers between the polymer substrate and metal layer.

The object of the present invention consists of the provision of a decorative structural part whose surface exhibits in full or in parts, a composite material of a plastic and a metal layer, which structural part overcomes the disadvantages of the state of the art described above and can be manufactured on an industrial scale.

The object is achieved according to the invention by the use of an article whose surface exhibits a composite material, in full or in parts, the composite material consisting of a non-metallic substrate containing at least one polymer, and a metallic layer present thereon and deposited without external current, having an adhesive strength of at least 4 N/mm², as decorative structural part.

In an embodiment of the present invention which is particularly preferred, an object is used as decorative structural part whose surface exhibits a composite material, in full or in parts, the composite material exhibiting a first non-metallic layer and a second metallic layer applied thereon and
a) the surface of the article not being chemically pretreated before the application of the metallic layer; and
b) the metallic layer not being applied by thermal spraying, CVD, PVD or laser treatment.

Chemical pretreatment should be understood here and subsequently, as a delimitation to mechanical treatments, any treatment of a substrate surface which is carried out by pickling, etching, swelling, vapour deposition, plasma treatment or similar methods and in the case of which a change to the surface is caused by a chemical reaction.

In contrast to the articles of the state of the art metallised after chemical pretreatment, the articles according to the present invention used exhibit a rough, sharp-edged boundary layer between the non-metallic layer and the metallic layer applied without external current. These sharp edged indentations and undercuts of the boundary layer are clearly recognisable as edged surface contours, e.g. in a microtome section analysis whos execution is described in the following. Thus, they can be distinguished from the rather roundish, and in any case rounded-off contours which are formed by a chemical pretreatment (FIG. 2).

The adhesive strengths (indicated in N/mm²) of the composite materials according to the invention are determined exclusively by way of the frontal tensile test according to DIN 50160:

The frontal tensile test (vertical tensile test) according to DIN 50160 has been used for many years for testing semiconductors, the determination of the adhesive tensile strength of thermally sprayed layers and in various coating techniques.

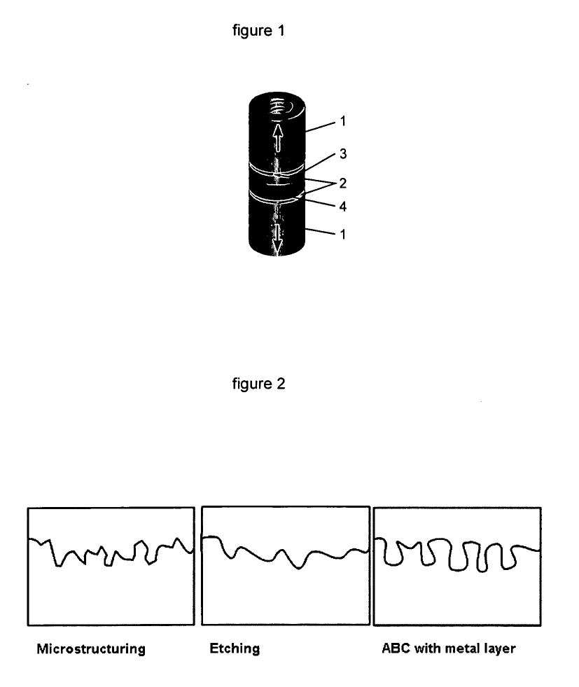

For the determination of the adhesive strength by the frontal tensile test, the layer/substrate composite to be tested is bonded between two test dies and subjected to a load under a single-axis force up to rupture (compare FIG. 1). If the adhesive strength of the adhesive is greater than that of the coating and the rupture occurs between the layer and the substrate, it is possible to calculate the adhesive strength according to the equation

$${σ}_{H exp} = \frac{{F}_{max}}{{A}_{G}}$$

(with σ_{H exp}: experimentally determinable adhesive strength, Fₘₐₓ: maximum force on rupture of the composite and A_{G}: geometric surface of rupture).

In a preferred embodiment, the standard deviation of the adhesive strength at six different measured value points distributed over the surface of the composite material is maximum 25% of the arithmetic mean.

The homogeneity of the adhesive strength indicated permits the use according to the invention of articles with a composite material as decorative structural parts in a particular manner. Thus, the articles exhibit an increased suitability for everyday use and are resistant to wear and tear such that entirely new fields of application can be developed.

According to a further preferred embodiment, an article is used whose composite material exhibits a non-metallic substrate which is simultaneously the surface of the article. Preferably, these surfaces are based on a polymeric material. Fibre-reinforced plastics, thermoplastics and other industrially used polymers are to be mentioned as being particularly preferred.

Similarly, however, it is also possible to use articles whose non-metallic substrate is not the surface of the article. Thus, the article used can consist of a metallic or ceramic material which is coated with a non-metallic substrate which contains at least one polymer. Examples in this respect are a coated emblem of aluminium which is selectively metallised, or a metal casing which is coated with a powder coating and partly metallised.

In a further embodiment of the present invention, an articles with a composite material is used as decorative structural part which exhibits a boundary present between the non-metallic substrate and the metallic layer with a roughness whose R_{z} value does not exceed 35 μm.

The R_{z} value is a measure of the average vertical surface fragmentation.

According to an embodiment of the present invention which is particularly preferred, articles with a composite material are used as decorative structural parts, which exhibit a boundary present between the non-metallic substrate and the metallic layer with a roughness expressed by an Rₐ value of maximum 5 μm.

The Rₐ value is a measure reproducible by measuring techniques of the roughness of surfaces, profile runaways (i.e. extreme troughs or elevations) being largely ignored in the surface integration.

To determine the roughness values Rₐ and R_{z}, a specimen is taken from an article according to the invention and a microtome section is made according to the method detailed as follows.

When making the microtome section, there is the particular difficulty that the boundary surface between the substrate and the surface can be very rapidly destroyed or detached by the treatment. To avoid this, a new separation disc from Struer, type 33TRE DSA No. 2493, is used for each microtome section. Moreover, care must be taken to ensure that the application pressure which is transferred from the separation disc onto the substrate coating is directed such that the force flows from the coating in the direction towards the substrate. During the separation, care must be taken to ensure that the application pressure is kept as low as possible.

The specimen to be examined is placed into a transparent embedding mass (Epofix putty, obtainable from Struer). The embedded specimen is ground in a table grinding machine from Struer, type KNUTH-ROTOR-2. Different abrasive papers with silicon carbide and different granulations are used for this purpose. The exact sequence is as follows:

| | Granulation | Time |
|---|---|---|
| First grinding treatment | P800 | approximately 1 min |
| Second grinding treatment | P1200 | approximately 1 min |
| Third grinding treatment | P2400 | approximately 30 sec |
| Fourth grinding treatment | P 4000 | approximately 30 sec |

During the grinding process, water is used in order to remove the grinding particles. The tangential force which arises at the cross-section and by friction is directed in such a way that the metallic layer is pressed against the non-metallic substrate. In this way, the metallic layer is effectively prevented from detaching itself from the non-metallic substrate during the grinding process.

Subsequently, the specimen thus treated is polished with a motor-driven preparation device of the DAP-A type from Struer. For this process, it is not the usual specimen mover which is used but the specimen is instead polished exclusively by hand. Depending on the substrate to be polished, a torque of between 40 to 60 rpm/min and an application force between 5 and 10 N is used.

The microtome section is subsequently subjected to SEM micrography. For the determination of the boundary line enlargement, the boundary line of the layer between the non-metallic substrate and the metallic surface is determined with a 10,000 fold magnification. For the evaluation, the OPTIMAS program from Wilhelm Mikroelektronik is used. The result is determined in the form of the X—Y value pairs which describe the boundary line between the substrate and the layer. To determine the boundary layer magnification in the sense of the present invention, a distance of at least 100 μm is required. The course of the boundary layer needs to be determined with at least 10 measuring points per μm in this case. The boundary layer magnification is determined from the quotient of the true length by the geometric length. The geometric length corresponds to the distance of the measured distance, i.e. the distance between the first and the last measuring point. The true length is the length of the line which passes through all the measuring points recorded.

The surface roughness value Rₐ is determined according to the standard DIN 4768/ISO 4287/1 again using the X—Y value pairs recorded before.

According to a further embodiment of the present invention which is also preferred, the non-metallic substrate contains at least one fibre-reinforced polymer, in particular a polymer reinforced with carbon fibres, and the diameter of the fibre is less than 10 μm.

Moreover, in a further form of the present invention, the non-metallic substrate may contain at least one fibre-reinforced polymer, in particular a polymer reinforced with glass fibre, the diameter of the fibre amounting to more than 10 μm.

Insofar as the composite materials are subject not only to thermal stresses but also to mechanical stresses, reinforced plastics, in particular plastics reinforced with carbon fibre (PRF), plastics reinforced with glass fibre (CRP) and also plastics reinforced with aramite fibres or plastics reinforced with mineral fibres are used particularly preferably.

By using these articles, a high rigidity of the resulting structural parts is achieved with a low weight which structural parts are of particular interest for industrial application, e.g. for structural parts for the cabin area of aeroplanes, because of their low cost. In particular, polymers reinforced with glass fibre used as a component of the non-metallic substrate exhibiting fibres with a diameter of more than 10 μm are very cheap and easy to process. The fibre diameter has a strong influence on the roughness values such that, in the case of such materials according to the present invention, a roughness value Rₐ of maximum 10 μm is achieved. At the same time, it is possible according to the invention to achieve excellent values for the adhesive strength. In addition, the articles used according to the invention have a high homogeneity of adhesion. This makes it possible for the first time to substantially increase the service life of the decorative structural part since even a local delamination of the layer composite leads to failure of the structural part as a whole. Of particular weight is the advantage in the case of structural parts with a surface covered by the layer composite of more than 10 dm², i.e. in the case of large structural parts or structural parts with a large surface area.

In a further embodiment, the article described above exhibits a boundary between the non-metallic substrate and the metallic layer which exhibits a roughness with an R_{z} value of maximum 100 μm.

For the use of fibre-reinforced polymers, in particular, whose fibre thickness is more than 10 μm, it is important to achieve R_{z} values which are as low as possible. In the case of this combination, it is, surprisingly, possible to achieve high adhesive strengths with—in comparison to the fibre diameters used—low R_{z} values.

In a preferred embodiment of the invention, the polymer of the non-metallic layer is selected from the group of polyamide, polyvinyl chloride, polystyrene, epoxy resins, polyether ether ketone, polyoxymethylene, polyformaldehyde, polyacetal, polyurethane, polyether imide, polyphenyl sulphone, polyphenylene sulphide, polyarylamide, polycarbonate and polyimide.

In the case of this embodiment, the metallic layer may exhibit an adhesive strength of at least 12 N/mm².

However, in another embodiment of the present invention, the polymer of the non-metallic substrate may similarly also be selected from polypropylene or polytetrafluoroethylene.

In those cases in which the non-metallic layer contains either polypropylene and/or polytetrafluoroethylene, adhesive strengths of at least 4 N/mm² are achieved. This represents an excellent value, in particular in combination with the high homogeneity of the adhesive strength which could not be achieved previously.

Embodiments according to the invention are particularly preferred which exhibit a standard deviation of the adhesive strength of six different measured value points distributed over the surface of the layer composite of maximum 25%, in particular maximum 15%, of the arithmetic mean.

In this way, an even higher mechanical resistance to stress of the resulting structural parts is guaranteed.

According to a further embodiment of the present invention, which is also preferred, the metal layer deposited without electric current is a metal alloy or metal dispersion layer.

In this way, articles with a composite material can be used as decorative structural parts for the first time which exhibit an excellent adhesion of the metallic layer to the non-metallic substrate. The homogeneity of the adhesion of the metallic layer also plays an important part for the suitability of these articles as structural parts subjected to high stress. A controlled selection of the non-metallic substrate and the metallic layer present thereon allows an accurate adjustment of the property profile to the conditions of the field of use.

Particularly preferably, a copper, nickel or gold layer is applied onto the non-metallic layer of the article used according to the invention as a metal layer deposited without external current.

However, a metal alloy or metal dispersion layer deposited without external current can also be applied, preferably a copper, nickel or gold layer with embedded non-metallic particles. In this respect, the non-metallic particles may exhibit a hardness of more than 1,500 HV and may be selected from the group of silicon carbide, corundum, diamond and tetraboron carbide.

These dispersion layers consequently have other functions, apart from the properties described above; for example, the resistance to wear and tear or surface wetting of the articles used can be improved.

Also preferably, the non-metallic particles may exhibit friction-reducing properties and be selected from the group of polytetrafluoroethylene, molybdenum sulphide, cubic boron nitride and tin sulphide.

The articles of the present invention are obtained particularly preferably by means of a special process which comprises the following steps:
i. the surface of the non-metallic layer is not chemically pretreated before applying the metallic layer;
ii. the surface of the non-metallic layer is microstructured in a first step by a blasting agent;
iii. the metallic layer is subsequently applied by metal deposition without external current.

The articles according to the present invention to be used as decorative structural parts exhibit, as composite material, first of all a non-metallic substrate which contains at least one polymer. To produce the composite material according to the invention, the surface of the non-metallic substrate is microstructured in a first step by means of a blasting treatment. The process used is described in DE 197 29 891 A1, for example. Inorganic particles resistant to wear and tear, in particular, are used as blasting agent. Preferably, these consist of copper-aluminium oxide or silicon carbide. It has proven advantageous in this respect that the blasting agent has a particle size of between 30 and 300 μm. It is further described therein that a metal layer can be applied by means of metal deposition without external current onto surfaces roughened in this way.

As the designation of the process already indicates, no electric energy is supplied from outside during the coating process in the case of the metal deposition without electric current but instead the metal layer is deposited exclusively by a chemical reaction. The metallisation of non-conductive plastics in a metal salt solution operating by chemical reduction requires a catalyst at the surface in order to interfere with the metastable equilibrium of the metal reduction bath there and to deposit metal on the surface of the catalyst. This catalyst consists of noble metal seeds such as palladium, silver, gold and occasionally copper which are added onto the plastic surface from an activator bath. However, an activation with palladium seeds is preferred for process technology reasons.

Essentially, the activation of the substrate surface takes place in two steps. In a first step, the structural part is immersed into a colloidal solution (activator bath). In this respect, the palladium seeds necessary for the metallisation and already present in the activator solution are adsorbed to the plastic surface. After seeding, the tin(II) and/or tin(IV) oxide hydrate which is additionally formed on immersion into the colloidal solution is dissolved by rinsing in an alkaline aqueous solution (conditioning) and the palladium seed is exposed as a result. After rinsing, nickel coating or copper coating can take place using chemical reduction baths.

This is effected in a bath maintained in metastable equilibrium by means of a stabiliser, which bath contains both the metal salt and the reducing agent. The baths for the nickel and/or copper deposition have the characteristic of reducing the metal ions dissolved therein at the seeds and to deposit elementary nickel or copper. In the coating bath, the two reactants must approach the noble metal seeds on the plastic surface. As a result of the redox reaction taking place in this way, the conductive layer is formed, the noble metal seeds absorbing the electrons of the reducing agents in this case and releasing them again when a metal ion approaches. In this reaction, hydrogen is liberated. After the palladium seeds have been coated with nickel and/or copper, the layer applied takes on the catalytic effect. This means that the layer grows together starting out from the palladium seeds until it is completely closed.

As an example, the deposition of nickel will be discussed in further detail here. During coating with nickel, the seeded and conditioned plastic surface is immersed into a nickel metal salt bath which permits a chemical reaction to take place within a temperature range of between 82° C. and 94° C. In general, the electrolyte is a weak acid with a pH of between 4.4 and 4.9.

The thin nickel coatings applied can be strengthened with an electrolytically deposited metal layer. Coating of structural parts with layer thicknesses of >25 μm is not economical because of the low rate of deposition of chemical deposition processes. Moreover, only a few coating materials can be deposited using the chemical deposition processes such that it is advantageous to make use of electrolytic processes for further industrially important layer materials. A further essential aspect consists of the different properties of layers chemically and electrolytically deposited with layer thicknesses of >25 μm, e.g. levelling, hardness and gloss. The bases of electrolytic metal deposition have been described e.g. in B. Gaida, “Einführung in die Galvanotechnik” (Introduction into electroplating) “E. G. Leuze-Verlag, Saulgau, 1988 or in H. Simon, M. Thoma, “Angewandte Oberflächentechnik für metallische Werkstoffe” (Applied surface technology for metallic materials) “C. Hanser-Verlag, Munich (1985).

Plastic parts which exhibit an electrically conductive layer as a result of a coating processes applied without electric current differ with respect to electrolytic metallisation only slightly from those of the metals. Nevertheless, a few aspects should not be disregarded in the case of the electrolytic metallisation of metallised polymers. As a result of the usually low conductive layer thickness, the current density must be reduced at the beginning of electrolytic deposition. If this aspect is ignored, a detachment and combustion of the conductive layer may occur. Moreover, care should be taken to ensure that undesirable layers of tarnish are removed by pickling baths particularly adapted for this purpose. Moreover, inherent stresses may lead to the destruction of the layer. In the case of deposits of nickel layers from an ammonia-containing bath, tensile stresses of the order of 400 to 500 MPa, for example, may occur. By means of additives such as saccharin and butine diol, a change to the structure of the nickel coatings in the form of a modified grain size and the formation of microdeformations may promote the decrease in internal stresses which may have a positive effect on a possible premature failure of the coating.

Examples of metal layers applied without external current are described in detail in the handbook of AHC Oberflächentechnik (“Die AHC-Oberfläche” Handbuch für Konstruktion und Fertigung, (“The AHC surface” Handbook for construction and manufacture”) 4^{th} edition 1999).

In addition, one or several further layers, in particular metallic, ceramic and crosslinked or cured polymer layers can be arranged on the metallic layer.

It is thus possible, for example to apply a further electrolytically deposited nickel layer onto a nickel layer deposited without electric current, as metallic layer of the present invention, and to deposit a chromium layer thereon. The electrolytic deposition of the second nickel layer is preferably carried out in order to be able to produce greater layer thicknesses more cost effectively.

Moreover, the articles of the present invention can exhibit a copper layer as metallic layer onto which subsequently a further copper layer can be applied. Subsequently a gold layer, for example, is applied onto the existing metal layers. Such coatings can be used to for the manufacture of gold-plated fitting, for example, e.g. in the hygiene or motor vehicle sector.

The articles used according to the present invention can also exhibit a nickel layer as metallic layer onto which a further nickel layer is applied. It is possible in this way to achieve a high rigidity of the resulting plastic parts, thus guaranteeing an application for components subject to high mechanical stress.

Moreover, metallic layers can be applied onto an article with a metallic layer according to the present invention not only electrolytically but also by means of other processes such as CVD/PVD.

In this way, it is possible to apply aluminium or stainless steel onto an article which consists e.g. of plastic and has been provided with a nickel layer according to the present invention.

A further interesting example of an article according to the invention is a plastic which is provided first with a nickel layer applied without electric current. Onto this nickel layer, layers of silver and gold are subsequently electrolytically applied one after the other.

Overall, the examples detailed above show that the articles according to the invention can be used in a very large field of technical applications.

For example, an article according to the present invention can be used as a casing, container, handle, cover, emblem, holder and decorative moulding.

### EXAMPLE

### According to the Invention

A panel of polyamide-6 with the dimensions 200×100×12 mm with an initial roughness of Rₐ=0.64 μm and R_{z}=7.5 μm was surface treated:

The surface pretreatment is carried out with a modified pressure blasting device from Straaltechnik International. The blasting device is operated at a pressure of 4 bar. A boron carbide nozzle with a diameter of 8 mm is used as jet nozzle. The blasting period is 4.6 s. SiC with the granulation P80 with an average grain diameter of 200 to 300 μm is used as blasting agent.

To adjust the blasting system specifically to the requirements of the plastic modification as regards reproducible surface topographies, 2 pressure circuits were installed, one each for transporting the blasting agent and the actual acceleration process respectively. This modification gave a highly constant volume stream and a large pressure range.

A stream of compressed air transports the blasting agent with a pressure as low as possible to the nozzle. The flow conditions guarantee a low wear and tear of the unit and the blasting agent as a result of a high volume stream of the blasting agent and a low proportion of compressed air. Only at the end of the conveying hose in front of the mixing nozzle is the cross section reduced in order to adjust the desired volume stream. In the case of all polymer pretreatments, a constant volume flow of 1 l/min was set. In the second part of the system, compressed air (volume stream 1) flows to the nozzle which can be adjusted steplessly within a pressure range of 0.2-7 bar. The blasting agent which is conveyed into the mixing nozzle at a very low flow rate is then accelerated by the high flow rate of the compressed air stream.

The panel roughened in this way is treated in an ultrasonic bath with a mixture of deionised water and 3% by vol. of butyl glycol for five minutes.

The series of baths used for the metal deposition of the conductive layer are based on the known colloidal palladium activation in association with a final catalysed metal reduction. All bath sequences required for this purpose were purchased from Max Schlötter. The immersion sequences, treatment times and treatment temperatures indicated by the manufacturer were maintained in all the process steps of nickel deposition:

(1) Preliminary activator immersion solution:
This is used to avoid the entrainment of contaminants and to completely wet the specimens before the actual activation of the surface.
Immersion time: 2 min, room temperature

(2) Activator GS 510:
Activation of the surface with tin/palladium colloid.
Immersion time: 4 min, room temperature

(3) Rinsing bath: deionised water
To avoid the entrainment of activator GS 510 components by rinsing in deionised water.
Immersion time: 1 min, room temperature

(4) Conditioner 101:
Conditioning of the material surface by removing undesirable tin compounds from the surface.
Immersion time: 6 min, room temperature

(5) Rinsing bath: deionised water.
Immersion time: 1 min, room temperature

(6a) Chemical nickel bath SH 490 LS:
Metallising of the plastics with a light-coloured, semi-bright amorphous layer at a separation temperature of 88-92° C.
Immersion time: 10 minutes

In the case of the selected immersion time in the nickel bath, a layer thickness of 1.4 μm was obtained. This thickness of the nickel layer is sufficient for an electrolytic coating. All process steps necessary for depositing the conductive layer took place in a plastic tub holding 50 l, a bath temperature of 90°±0.5° C. being maintained throughout the entire coating cycle during the nickel deposition by means of an additional hot plate with temperature control. In order to obtain a homogeneous and reproducible layer quality, the series of baths were analysed and supplemented according to information provided by Max Schlötter after putting through 20 specimens.

After chemically applying the conductive nickel layer, the specimen was cooled in distilled water from approximately 90° C. to approximately 60° C. in order to be then coated further electrolytically with nickel at 55° C. This intermediate step had the purpose of avoiding the formation of reaction layers and excluding inherent stresses caused by rapid cooling. The specimens which were coated exclusively with a conductive nickel layer cooled slowly to 25° C. in a distilled water bath.

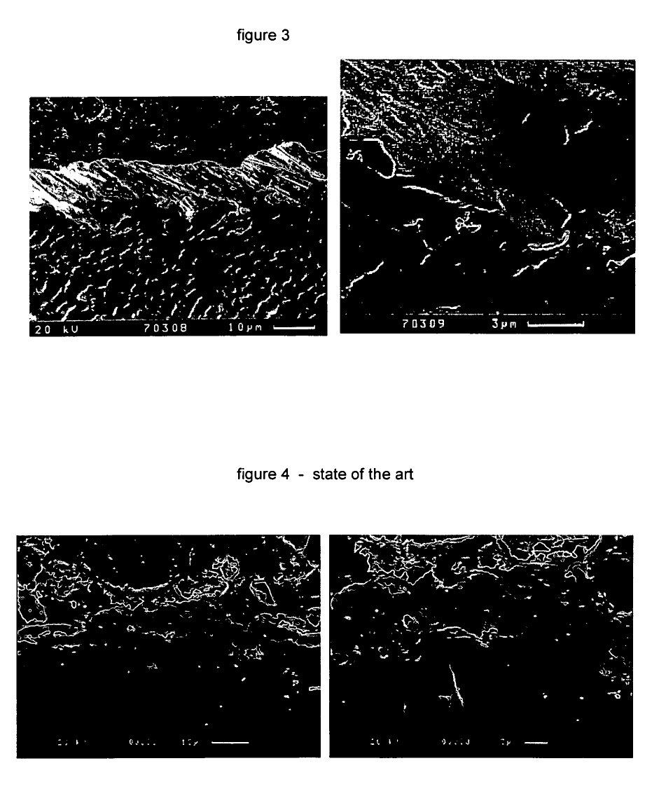

The microtome section investigations by SEM (1,500 fold and 3,000 fold) are represented in the following figures (FIG. 3).

The results of the adhesive strength investigations are show in Table 1.

TABLE 1

| No. | Adhesive Strength |
|---|---|
| 1 | 20.5 N/mm² |
| 2 | 19.5 N/mm² |
| 3 | 13.4 N/mm² |
| 4 | 16.4 N/mm² |
| 5 | 22.3 N/mm² |
| 6 | 20.3 N/mm² |
| 7 | 16.8 N/mm² |
| 8 | 14.5 N/mm² |
| 9 | 13.2 N/mm² |
| 10 | 12.9 N/mm² |
| 11 | 16.7 N/mm² |
| 12 | 24.5 N/mm² |
| 13 | 18.4 N/mm² |
| 14 | 19.2 N/mm² |
| 15 | 15.4 N/mm² |
| 16 | 22.9 N/mm² |
| 17 | 16.7 N/mm² |
| 18 | 17.3 N/mm² |
| 19 | 12.8 N/mm² |
| 20 | 14.5 N/mm² |
| 21 | 18.2 N/mm² |
| 22 | 19.7 N/mm² |
| 23 | 23.4 N/mm² |
| 24 | 18.9 N/mm² |
| 25 | 20.1 N/mm² |
| 26 | 21.4 N/mm² |
| Standard deviation | 3.4 N/mm² |
| Mean | 18.1 N/mm² |
| Coefficient of variation | 19% |

### COMPARATIVE EXAMPLE

### Not According to the Invention

The example according to the invention is repeated; however, after the blasting treatment, the panel is treated in an ultrasonic bath, in a suspension of 5% by weight of CaCO₃ in 96% ethanol for 5 minutes.

Subsequently, the panel is treated in a further ultrasonic bath with pure 96% ethanol for a further five minutes.

The microtome section investigations by SEM (1,500 fold and 3,000 fold) are shown in the following figures (FIG. 4).

The evaluation of the EDX analysis gave resisdual quantity of calcium of 0.91% by weight which originates from the treatment of the CaCO₃/ethanol suspension.

The results of the adhesive strength investigations are shown in Table 2.

TABLE 2

| No. | Adhesive Strength |
|---|---|
| 1 | 9.9 N/mm² |
| 2 | 19.1 N/mm² |
| 3 | 10.1 N/mm² |
| 4 | 13.1 N/mm² |
| 5 | 16.6 N/mm² |
| 6 | 10.3 N/mm² |
| 7 | 19.8 N/mm² |
| 8 | 13.3 N/mm² |
| 9 | 21.4 N/mm² |
| 10 | 10.9 N/mm² |
| 11 | 20.0 N/mm² |
| 12 | 10.9 N/mm² |
| 13 | 11.7 N/mm² |
| 14 | 13.0 N/mm² |
| 15 | 16.4 N/mm² |
| 16 | 14.1 N/mm² |
| 17 | 15.4 N/mm² |
| 18 | 10.5 N/mm² |
| 19 | 15.8 N/mm² |
| 20 | 16.7 N/mm² |
| 21 | 8.5 N/mm² |
| 22 | 17.2 N/mm² |
| 23 | 7.0 N/mm² |
| 24 | 18.2 N/mm² |
| 25 | 7.2 N/mm² |
| 26 | 19.4 N/mm² |
| Standard deviation | 4.2 N/mm² |
| Mean | 14.1 N/mm² |
| Coefficient of variation | 29.8% |

The results clearly show a significant difference between the standard deviation of the adhesive strength of the different measured valued points distributed over the surface of the composite material.

During the use of door handles of polyamide for motor vehicles, for example, this difference causes the thermal resistance vis-à-vis temperature fluctuations, apart from the optical properties of the structural part, to be guaranteed for a period of more than 15 years without local delaminations occuring.

1. Use of an article whose surface exhibits a composite material in full or in parts, the composite material consisting of a non-metallic substrate containing at least one polymer, and a metallic layer present thereon and deposited without external current, having an adhesive strength of at least 4 N/mm², as decorative structural part.

2. Use according to claim 1 characterised in that the standard deviation of the adhesive strength at six different measured value points distributed over the surface of the composite material is maximum 25% of the arithmetic mean.

3. Use according to claim 1 characterised in that
a) the surface of the article is not chemically pretreated before the application of the metallic layer deposited without electric current; and
b) the metallic layer is not applied by thermal spraying, CVD, PVD or laser treatment.

4. Use according to claim 1 characterised in that the non-metallic substrate is the surface of the article.

5. Use according to claim 1 characterised in that the non-metallic substrate is not the surface of the article.

6. Use according to claim 1 characterised in that the boundary present between the non-metallic substrate and the metallic layer exhibits a roughness with an R_{z} value of maximum 35 μm.

7. Use according to claim 1 characterised in that the boundary present between the non-metallic substrate and the metallic layer exhibits a roughness with an Rₐ value of maximum 5 μm.

8. Use according to claim 1 characterised in that the non-metallic substrate contains at least one fibre-reinforced polymer, in particular a polymer reinforced with carbon fibre and the diameter of the fibre is less than 10 μm.

9. Use according to claim 1 characterised in that the non-metallic substrate contains at least one fibre-reinforced polymer, in particular a polymer reinforced with glass fibre and the diameter of the fibre is more than 10 μm.

10. Use according to claim 9 characterised in that the boundary present between the non-metallic substrate and the metallic layer exhibits a roughness with an Rₐ value of maximum 10 μm.

11. Use according to claim 1 characterised in that the boundary present between the non-metallic substrate and the metallic layer exhibits a roughness with an R_{z} value of maximum 100 μm.

12. Use according to claim 1 characterised in that the polymer is selected from the group of polyamide, polyvinyl chloride, polystyrene, epoxy resin, polyether ether ketone, polyoxymethylene, polyformaldehyde, polyacetal, polyurethane, polyether imide, polyphenyl sulphone, polyphenylene sulphide, polyarylamide, polycarbonate and polyimide.

13. Use according to claim 12 characterised in that the metallic layer exhibits an adhesive strength of at least 12 N/mm²

14. Use according to claim 1 characterised in that the non-metallic substrate is polypropylene or polytetrafluoroethylene.

15. Use according to claim 1 characterised in that the standard deviation of the adhesive strength amounts to maximum 25%, in particular maximum 15%, of the arithmetic mean.

16. Use according to claim 1 characterised in that the metal layer deposited without electric current is a metal alloy or metal dispersion layer.

17. Use according to claim 1 characterised in that the metal layer deposited without external current is a copper, nickel or gold layer.

18. Use according to claim 1 characterised in that the metal dispersion layer deposited without external current is a copper, nickel or gold layer with embedded non-metallic particles.

19. Use according to claim 18 characterised in that the non-metallic particles exhibit a hardness of more than 1,500 HV and are selected from the group of silicon carbide, corundum, diamond and tetraboron carbide.

20. Use according to claim 18 characterised in that the non-metallic particles exhibit friction-reducing properties and are selected from the group of polytetrafluoroethylene, molybdenum sulphide, cubic boron nitride and tin sulphide.

21. Use according to claim 1 as casing, container, handle, cover, emblem, holder and decorative moulding.
